(19) United States
(12) Patent Application Publication
(10) Pub. No.: US 2013/0229791 A1
(43) Pub. Date: Sep. 5, 2013

(54) BIDIRECTIONAL LIGHTING DEVICE FOR A RIM

(71) Applicants: Rocky Yi-Ping LIN, Taipei City (TW); Kun-Hsiang Wang, Taipei City (TW)

(72) Inventors: Rocky Yi-Ping LIN, Taipei City (TW); Kun-Hsiang Wang, Taipei City (TW)

(73) Assignee: Rocky Yi-Ping LIN

(21) Appl. No.: 13/445,326

(22) Filed: Apr. 12, 2012

(30) Foreign Application Priority Data
Mar. 3, 2012 (TW) 101203787

(51) Int. Cl. F21L 4/02

(52) U.S. Cl. 362/184

(57) ABSTRACT

A bidirectional lighting device for a rim includes a casing, a light-emitting module, a reflecting element, and a power supply unit. The casing includes a lower base and an upper cover both provided with a transparent region respectively. The light-emitting module is received in the casing and has light-emitting diodes arranged in a strip. The reflecting element is mounted in the casing to correspond to the transparent regions. The reflecting element has a first reflecting surface and a second reflecting surface both located on one side of the light-emitting diodes. The light generated by the light-emitting diodes is reflected by the first and second reflecting surfaces to exit the transparent regions. The power supply unit is received in the casing to be electrically connected with the light-emitting module. Thus, the light of the light-emitting diodes can be emitted out of the casing in two directions.

### BACKGROUND OF THE INVENTION

1. Field of the Invention

The present invention relates to a lighting device, and in particular to a bidirectional lighting device for a rim.

2. Description of Prior Art

The conventional lighting device for a rim is provided with a plurality of light-emitting units on a plate. The light-emitting diodes are all located on the same side of the plate. If the lighting device is to emit light in two directions, the other side of the plate has to be provided with a plurality of light-emitting units of the same number. By this arrangement, emitting light in two directions can be achieved.

However, since a lot of light-emitting units are provided on both sides of the plate of the conventional lighting device for a rim, the production cost of the lighting device is high. On the other hand, the double light-emitting units consume the electricity of a battery faster, which reduces the lifetime of the lighting device. Further, the fixation between the plate and the rim is achieved by binding bands, so that the lighting device may displace or slide off during the rotation of the rim. Even, the lighting device may often collide with the rim to generate an electric circuit easily.

### SUMMARY OF THE INVENTION

The present invention is to provide a bidirectional lighting device for a rim, in which two reflecting surfaces formed by a reflecting element are used to reflect the light of respective light-emitting diodes out of a casing in two directions.

The present invention provides a bidirectional lighting device for a rim, including a casing, a light-emitting module, a reflecting element, and a power supply unit. The casing includes a lower base and an upper cover combined with the lower base. The upper cover and the lower base are provided with a transparent region respectively. The light-emitting module is received in the casing and has a plurality of light-emitting diodes arranged in strips. The reflecting element is mounted in the casing at a position corresponding to the respective transparent regions. The reflecting element has a first reflecting surface and a second reflecting surface intersecting the first reflecting surface. The first reflecting surface and the second reflecting surface are located on one side of the respective light-emitting diodes, so that the light generated by the respective light-emitting diodes can be reflected by the first reflecting surface and the second reflecting surface to exit the transparent regions. The power supply unit is received in the casing to be electrically connected with the light-emitting module.

The present invention has the following advantageous effects. The efficiency of consuming electricity is reduced, and the lifetime of the power supply unit is extended. The lighting device can be firmly fixed on the rim by a fixing means.

### BRIEF DESCRIPTION OF DRAWING

FIG. 1 is an exploded perspective view showing the bidirectional lighting device of the present invention;

FIG. 2 is an assembled view showing the bidirectional lighting device of the present invention;

FIG. 3 is an assembled view showing the external appearance of the bidirectional lighting device of the present invention;

FIG. 4 is an assembled cross-sectional view showing the bidirectional lighting device of the present invention;

FIG. 5 is an assembled view showing that the bidirectional lighting device of the present invention is applied to a rim;

FIG. 6 is an assembled cross-sectional view showing that the bidirectional lighting device of the present invention is applied to a rim; and

FIG. 7 is an assembled view showing that the bidirectional lighting device of the present invention is applied to a rim by another fixing means.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

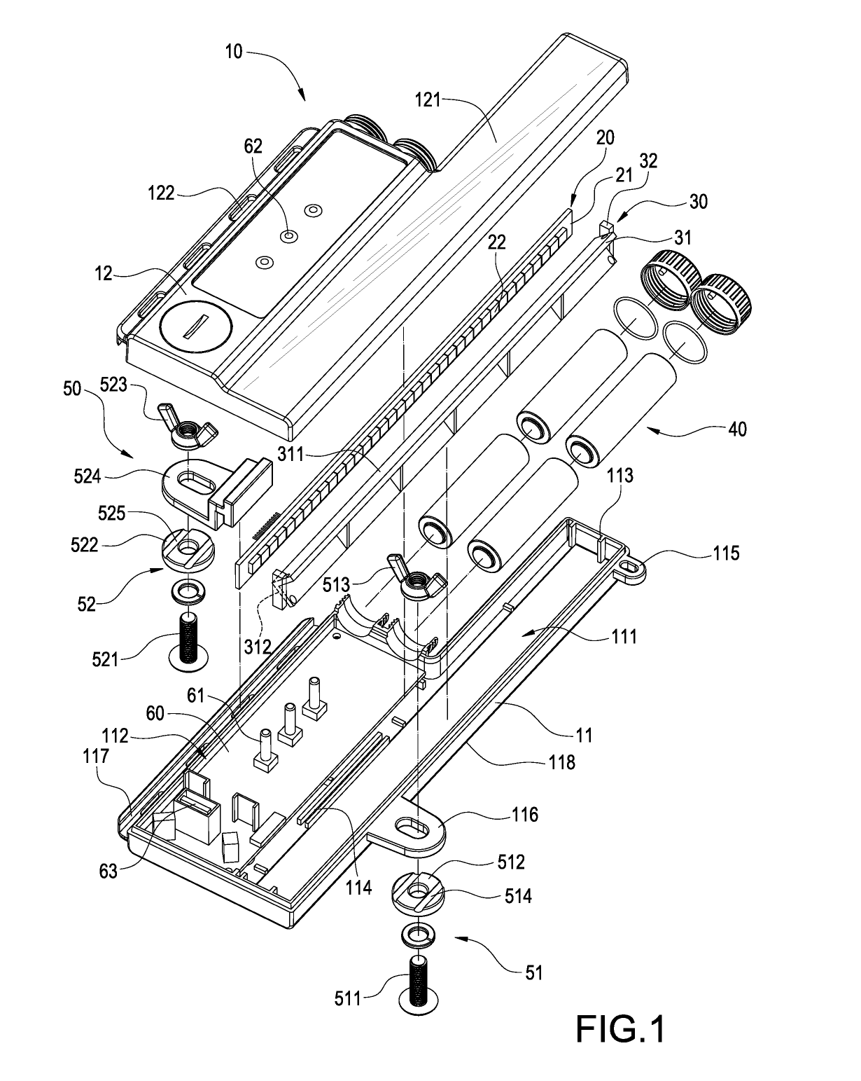

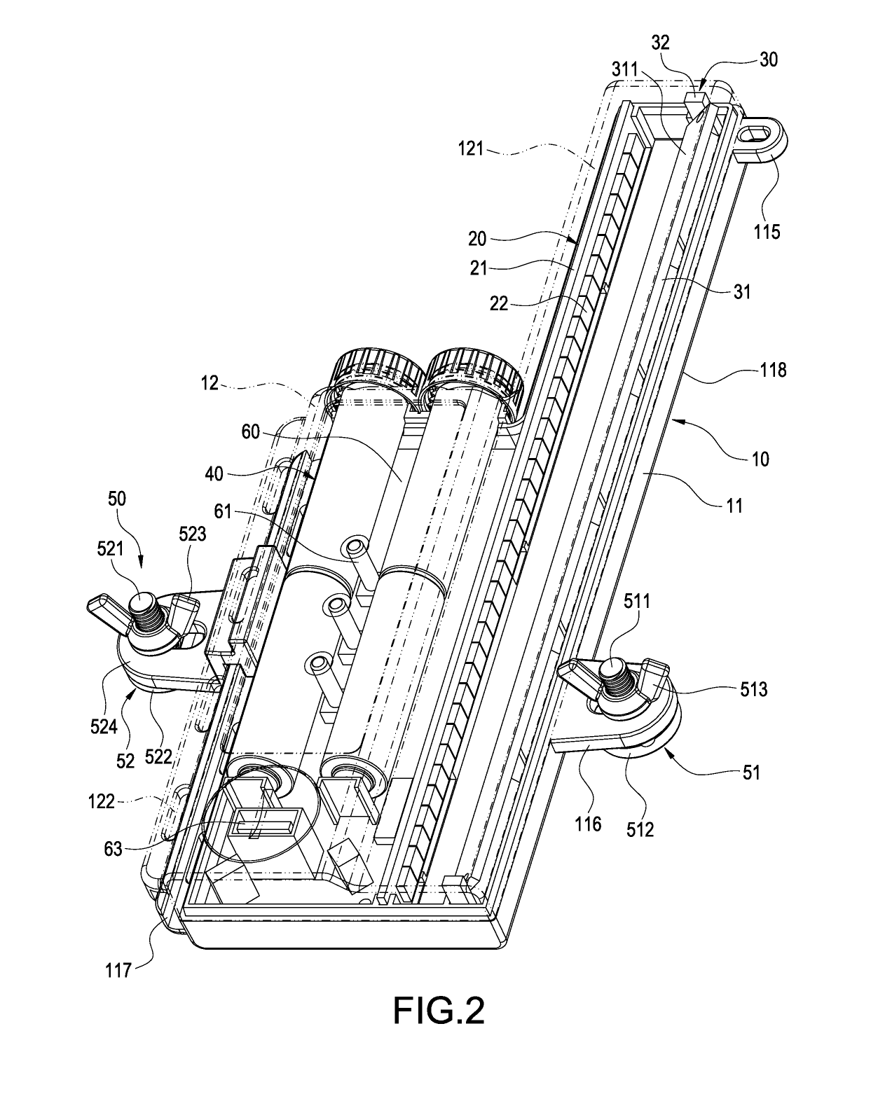

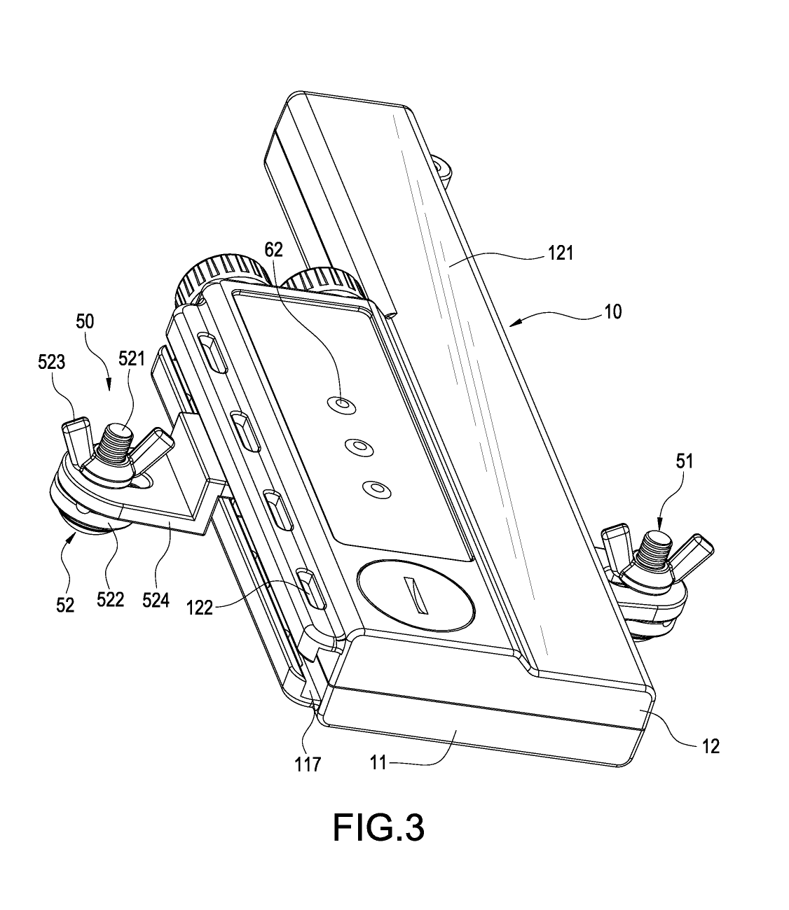

Please refer to FIGS. 1 to 4. The present invention relates to a bidirectional lighting device for a rim, which includes a casing 10, a light-emitting module 20, a reflecting element 30, and a power supply unit 40.

The casing 10 is substantially formed into an L shape, which includes a lower base 11 and an upper cover 12. The interior of the lower base 11 has a first accommodating portion 111 and a second accommodating portion 112. The interior of the first accommodating portion 111 of the lower base 11 is formed with a pair of retaining strips 113 and an insertion trough 114. The right side of the lower base 11 is formed with an upper lug 115 and a lower lug 116. The left side of the lower base 11 is provided with a guiding slot 117. The interior of the second accommodating portion 112 of the lower base 11 is accommodated with a controller 60. The controller 60 is provided with a plurality of touch switches 61 and electrically connected to a USB jack 63. The USB jack 63 is disposed in the lower base 11 for charging the light-emitting module 20 or updating internal programs for light-emitting module 20. In this way, the light-emitting module 20 can generate different light effects (such as ON/OFF of the light, duration of ON state or OFF state, change in color temperatures). The lower base 11 has a transparent region 118 at a position corresponding to the first accommodating portion 111. The lower base 11 may be also made of transparent materials, so that the whole lower base 11 is configured as a transparent element.

The upper cover 12 is combined with the lower base 11. The upper cover 12 is provided with a plurality of buttons 62 facing the touch switches 61 at positions corresponding to the location of the controller 60 respectively. The upper cover 12 has a transparent region 121 above the first accommodating portion 111. Similarly, the upper cover 12 may be also made of transparent materials, so that the whole upper cover 12 is configured as a transparent element. The left side of the upper cover 12 is provided with a plurality of through troughs 122.

The light-emitting module 20 is received in the first accommodating portion 111 of the casing 10. The light-emitting module 20 includes a circuit board 21 and a plurality of light-emitting diodes 22 arranged on the circuit board 21 in a line. Each light-emitting diode 22 is electrically connected to the circuit board 21. The circuit board 21 is inserted into the insertion trough 114. Each light-emitting diode 22 is oriented toward the first accommodating portion 111. The circuit board 21 is electrically connected to the controller 60 via electrical conductive terminals.

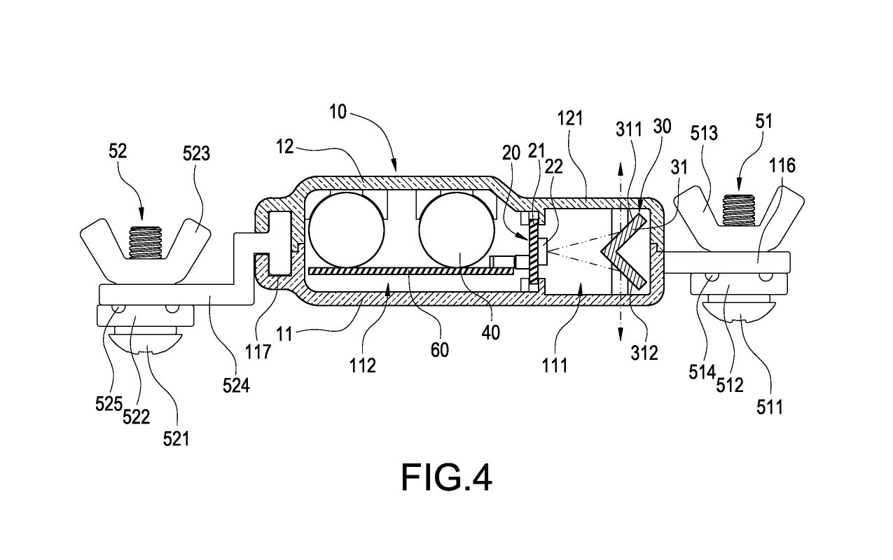

The reflecting element 30 is mounted in the first accommodating portion 111 of the casing 10 to correspond to the transparent regions 118 and 121. The reflecting element 30 has an elongate V-shaped plate 31. Both ends of the V-shaped plate 31 are connected with an insertion block 32 respectively. Each insertion block 32 is engaged with the retaining strip 113. The V-shaped plate 31 has a first reflecting surface 311 and a second reflecting surface 312 intersecting the first reflecting surface 311. The first reflecting surface 311 and the second reflecting surface 312 are located on one side of each light-emitting diode 22. The light emitted from the light-emitting diodes 22 can be reflected by the reflecting surfaces 311, 312 to exit the transparent regions 118, 121 respectively (FIG. 4).

In the present embodiment, the power supply unit 40 is a battery, but it is not limited thereto. The power supply unit 40 is received in the second accommodating portion 112 of the casing 10 and electrically connected with the light-emitting module 20 via the controller 60.

The bidirectional lighting device of the present invention further includes a fixing means 50. The fixing means 50 includes a first fixing assembly 51 and a second fixing assembly 52. The first fixing assembly 51 includes a screw rod 511, a clamping plate 512, and a wing nut 513. An end surface of the clamping plate 512 is provided with a trough 514. The screw rod 511 penetrates the clamping plate 512 and the lower lug 116 to be threadedly engaged with the wing nut 513. The second fixing assembly 52 includes a screw rod 521, a clamping plate 522, a wing nut 523, and an movable adjustment block 524. The movable adjustment block 524 is inserted into the guiding slot 117. An end surface of the clamping plate 522 is provided with a trough 525. The screw rod 521 penetrates the clamping plate 522 and the movable adjustment block 524 to be threadedly engaged with the wing nut 523.

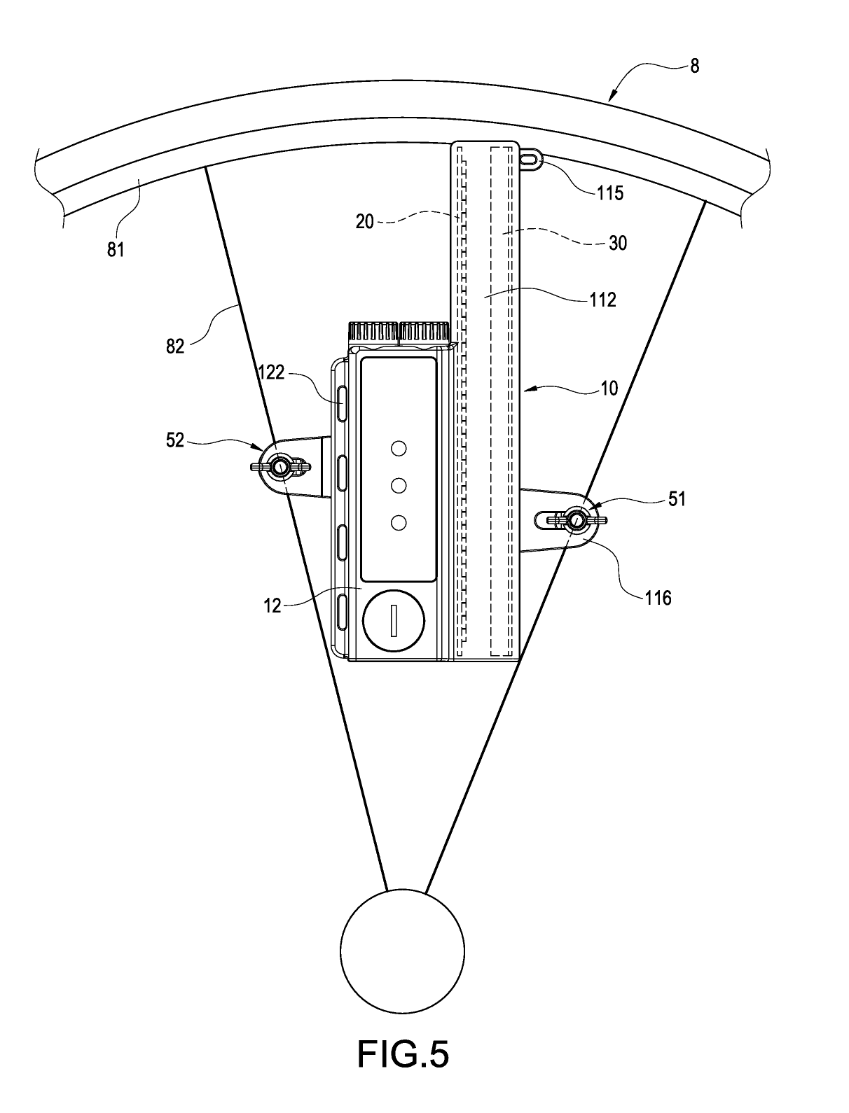

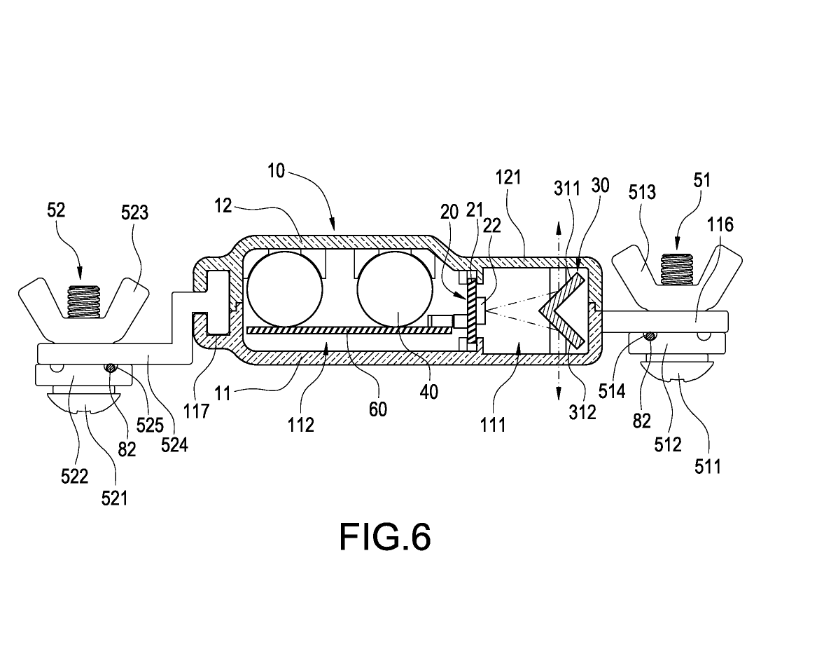

Please refer to FIGS. 5 and 6. The bidirectional lighting device of the present invention can be applied to a rim 8 of a bicycle. The rim 8 has a hub 81 and a plurality of supporting strips 82 connected to the hub 81. The casing 10 is disposed in a space between any two supporting strips 82. The trough 514 of the clamping plate 512 of the first fixing assembly 51 is used to press the supporting strips 82 with the clamping plate 512 being fixed to the end surface of the lower lug 116. One end of the movable adjustment block 524 of the second fixing assembly 52 is inserted into the guiding slot 117. The position of the movable adjustment block 524 relative to the casing 10 can be adjusted based on the locations of the respective supporting strips 82. Similarly, the trough 522 of the clamping plate 522 is used to press the supporting strips 82 with the clamping plate 522 being fixed to an end surface of the movable adjustment block 524.

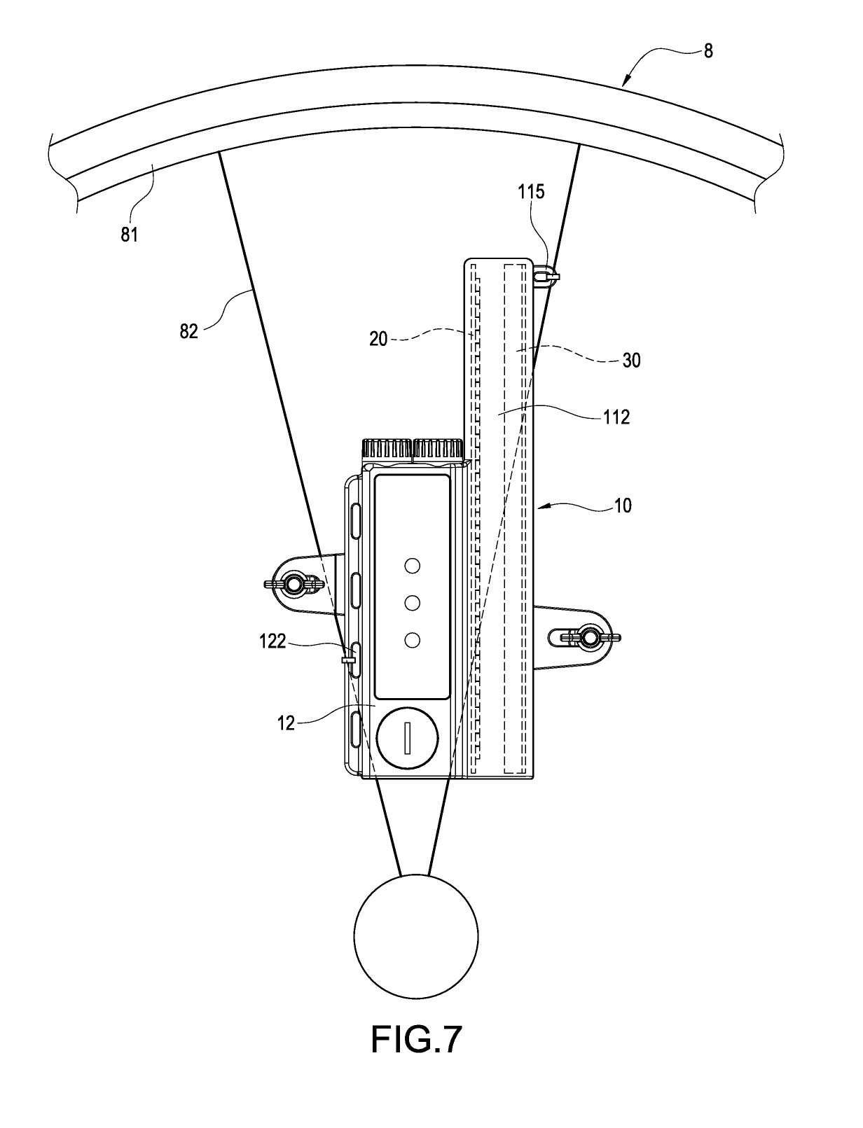

Please refer to FIG. 7. In addition to the above-mentioned manner for fixing the bidirectional lighting device of the present invention to the rim 8 of a bicycle, the upper lug 115 and the through trough 122 may be bound and fixed to the respective supporting rods 82 by binding bands.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A bidirectional lighting device for a rim, including:
a casing, comprising a lower base and an upper cover combined with the lower base, the upper cover and the lower base being provided with a transparent region respectively;
a light-emitting module, received in the casing and having a plurality of light-emitting diodes arranged in a line;
a reflecting element, mounted in the casing at a position corresponding to the respective transparent regions, the reflecting element having a first reflecting surface and a second reflecting surface intersecting the first reflecting surface, the first reflecting surface and the second reflecting surface being located on one side of the respective light-emitting diodes, light generated by the respective light-emitting diodes being reflected by the first reflecting surface and the second reflecting surface to exit the transparent regions; and
a power supply unit, received in the casing to be electrically connected with the light-emitting module.

2. The bidirectional lighting device for a rim according to claim 1, wherein the interior of the lower base has a first communicating portion and a second communicating portion, the light-emitting module and the reflecting element are disposed in the first accommodating portion, and the power supply unit is disposed in the second accommodating portion.

3. The bidirectional lighting device for a rim according to claim 2, wherein the interior of the first accommodating portion is formed with a pair of retaining strips, the reflecting element has an elongate V-shaped plate, both ends of the V-shaped plate are connected to an insertion block respectively, and the insertion blocks are engaged with the pair of retaining strips respectively.

4. The bidirectional lighting device for a rim according to claim 3, wherein the first reflecting surface and the second reflecting surface are formed on outer surfaces of the V-shaped plate respectively.

5. The bidirectional lighting device for a rim according to claim 2, wherein the interior of the first accommodating portion is formed with an insertion trough, the light-emitting module further includes a circuit board for allowing the light-emitting diodes to be arranged thereon, and the circuit board is inserted into the insertion trough.

6. The bidirectional lighting device for a rim according to claim 1, further including a fixing means, the fixing means comprising a first fixing assembly and a second fixing assembly, wherein a lower lug and a guiding slot protrude from the lower base, the first fixing assembly is connected to the lower lug, and the second fixing assembly is connected to the guiding slot.

7. The bidirectional lighting device for a rim according to claim 6, wherein the first fixing assembly includes a screw rod, a clamping plate and a wing nut, and the screw rod penetrates the clamping plate and the lower lug to be threadedly connected to the wing nut.

8. The bidirectional lighting device for a rim according to claim 7, wherein an end surface of the clamping plate is provided with a trough, the rim has a supporting rod, and the trough is positioned to press the supporting rod.

9. The bidirectional lighting device for a rim according to claim 6, wherein the second fixing assembly includes a screw rod, a clamping plate, a wing nut and an movable adjustment block, the casing is provided with a guiding slot, the movable adjustment block is inserted into the guiding slot, and the screw rod penetrates the clamping plate and the movable adjustment block to be threadedly connected to the wing nut.

10. The bidirectional lighting device for a rim according to claim 9, wherein an end surface of the clamping plate is provided with a trough, the rim has a supporting rod, and the trough is positioned to press the supporting rod.

11. The bidirectional lighting device for a rim according to claim 1, further including a controller disposed in the casing, the light-emitting module being electrically connected to the power supply unit via the controller.

12. The bidirectional lighting device for a rim according to claim 11, wherein the controller has a plurality of touch switches, and the upper cover is provided with a plurality of buttons at positions corresponding to the touch switches respectively.

13. The bidirectional lighting device for a rim according to claim 11, wherein the controller is electrically connected to a USB jack, and the USB jack is disposed in the lower base.
